(19) United States
(12) Patent Application Publication
(10) Pub. No.: US 2026/0237548 A1
(43) Pub. Date: Aug. 13, 2026

(54) CIRCUIT AND METHOD FOR DRIVING AN INDUCTIVE LOAD WITH REDUCED POWER LOSS

(71) Applicant: Robert D. BERNE, Cambridge, MD (US)

(72) Inventor: Robert D. BERNE, Cambridge, MD (US)

(21) Appl. No.: 19/048,141

(22) Filed: Feb. 7, 2025

(51) Int. Cl. H01F 7/18; H01F 7/06

(52) U.S. Cl. CPC H01F 7/1838; H01F 7/064

(57) ABSTRACT

Exemplary embodiments of the present disclosure provide a circuits and methods for passively and actively driving an inductive load. For an inductive load that includes a solenoid, when the solenoid is actuated and the mechanical component moves into the final position, the magnetic field strength of the solenoid needed for actuating the solenoid is not required to maintain the mechanical component in its final position. The difference in field strength can be about 100 times or greater to 1 in terms of required power during actuation and the power required to sustain the magnetic field strength. The exemplary embodiments disclosed herein, provide circuits and methods for controlling and/or driving an electro-magnetic coil actuated valve or solenoid with a 99% reduction of sustaining power consumption.

### FIELD

The disclosure relates to an inductive load, and particularly to methods and circuits for driving an inductive load.

### BACKGROUND

Inductive loads can take many forms. A solenoid is a coil of wire which moves a lever or piston when electrically energized. In some applications the solenoid can be configured as a valve, which is also known as a mechanical solenoid. These applications can be limited to momentary or periodic operation due to power consumption and thermal aging. When prolonged actuation is required, the solenoid is often arranged as a motorized valve, which can be considerably more expensive.

A known active circuit which includes an inductive load is shown in FIG. 1. During operation, power is supplied by V to coil L when switch SW is closed. The constant current applied results in power being generated. The switch can be configured as a power transistor driver stage or a relay. From known applications, power consumption in the circuit 100 can range from 8 watts to 35 watts. The coil L must be powered up using the rated voltage so that current can build in the coil to close or actuate the mechanical system. As a result, the coil L can be kept at or above the threshold power level by the nature of the control method. For example, in current applications, the coils are controlled with a power transistor in a control circuit.

Known solenoids are electro-mechanical devices with a magnetic element that moves to apply a force which opens or closes a valve, or some similar function. When the solenoid has a spring, kinetic detents, or stable positions, the activation energy is high due to the force required to move against the detent force. In the active state, a full normal operating voltage flows through the coil, and the coil consumes power at a constant level until deactivated.

During operation, the switch SW has two phases in its energized state. The first phase is an actuation phase, which requires considerable power to move the mechanical component into its position. In the first phase, the coil L must be powered up high enough to close or actuate the mechanical system. Once the mechanical component is in position, the switch SW moves to a second phase or sustaining phase. Sometime after the mechanical component moves into position, a magnetic field is established at the coil L. The sustaining phase requires less than 1% of the activation power.

FIG. 2 illustrates an exemplary plot of solenoid parameters during the sustaining phase exhibits a classic demonstration of the B-H magnetization curve which demonstrates the hysteresis of electromagnetics. As shown in FIG. 2, the coil has a full normal operating voltage flowing through it, and it consumes power at a constant level until deactivated.

An example of the difference in the power requirements of the first and second phases of the solenoid are observed from the empirical values of a 12-volt 1 amp 12-watt solenoid, which requires the aforementioned power requirements to move the mechanical component into an open position, but only requires 50-100 milliwatts of power to remain open once actuated.

Typically, these types of solenoids cannot be used for continuous duty due to heat stress. The longest time on for such devices is 6-8 hours with a 1 hour cool down period. Prolonged usage results in thermal erosion or fatigue of the coil and eventual failure. In many known implementations, solenoid valves are not sufficiently heat grounded, so they might add extra heat to a chemical process that can radically affect the outcome. Most of these solenoids are attached to and cooled by a pipe.

### SUMMARY

An exemplary passive circuit for actuating an inductive load of an application circuit, the passive circuit comprising: a power output circuit and a control circuit; the power output circuit including: a first capacitor (C1) and a first diode (D1) that are connected in series across a positive terminal and a negative terminal of the application circuit; a second diode (D4) having an anode connected at a node between the first capacitor (C1) and the first diode (D1), and a cathode connected to a gate of a first transistor (M1); the first transistor (M1) having a drain connected to a gate of a second transistor (M2), and a gate connected to the negative terminal of the application circuit; the second transistor (M2) having a drain connected to the anode of the second diode (D4) and a source connected to a cathode of a clamping diode (D6); and the clamping diode (D6) having an anode connected to the gate of a third transistor (M3), which has a drain and a source connected to the positive terminal and negative terminal, respectively, of the application circuit; the control circuit including: a constant voltage circuit connected to the gate of the third transistor (M3) and the negative terminal of the application circuit through an input diode (D7); an oscillator (U1) having an output connected to an inverting input terminal of a power modulator (U3); a voltage reference circuit (C7, R14, D8) connected to the negative terminal of the application circuit; and a comparator (U2) having a positive input connected to the positive terminal of the application circuit and a negative input connected to the voltage reference circuit (C7, R14, D8), wherein the second diode (D4) enters a conduct state when the application circuit reaches a specified voltage, which causes each of the first transistor (M1), the second transistor (M2), and the third transistor (M3) to enter a conducting state such that after a specified period the power output circuit shuts off, and wherein when a voltage value at the positive terminal of the comparator (U2) exceeds a voltage of the voltage reference circuit (C7, R14, D8), an output of the comparator is mixed with the output of the oscillator and causes the power modulator (U3) to provide an output voltage to the power output stage through the gate of the third transistor (M3) so that current flow through the load (L1) is increased and a magnetic field at the load (L1) is sustained.

An exemplary active circuit for actuating an inductive load of a load circuit is disclosed, the active circuit including a power output circuit and a control circuit; the power output circuit including: a first capacitor (C1) and a first diode (D1) that are connected in series across a positive terminal and a negative terminal of the load circuit; a second diode (D4) having an anode connected at a node between the first capacitor (C1) and the first diode (D1), and a cathode connected to a gate of a first transistor (M1); the first transistor (M1) having a drain connected to a gate of a second transistor (M2), and a gate connected to the negative terminal of the load circuit; the second transistor (M2) having a drain connected to the anode of the second diode (D4) and a source connected to a cathode of a clamping diode (D6); and the clamping diode (D6) having an anode connected to the gate of a third transistor (M3), which has a drain and a source connected to the positive terminal and negative terminal, respectively, of the load circuit; an active terminal (Pin 3) connected to an anode (AN11) of a third diode D11 and a cathode (CAT11) of the third diode D11 is connected to the gate (G3) of the third transistor (M3); and a disable terminal (Pin 5) connected to a cathode (CAT15) of the diode D15 and an anode (AN15) of the diode D15 is connected to the gate (G3) of the transistor (M3); the control circuit including: a constant voltage circuit connected to the gate of the third transistor (M3) and the negative terminal of the load circuit through an input diode (D7); an oscillator (U1) having an output connected to an inverting input terminal of a power modulator (U3); a voltage reference circuit (C7, R14, D8) connected to the negative terminal of the load circuit; and a comparator (U2) having a non-inverting input connected to the positive terminal of the load circuit and an inverting input connected to the voltage reference circuit (C7, R14, D8), wherein a load voltage across the positive and negative terminals of the load circuit, a first voltage to the active terminal, and the second diode (D4) enters a conducting state when the load circuit reaches a specified voltage less than the load voltage, which causes each of the first transistor (M1), the second transistor (M2), and the third transistor (M3) to enter a conducting state such that after a specified period the power output circuit shuts off; and wherein when a voltage value at the non-inverting terminal of the comparator (U2) exceeds a voltage of the voltage reference circuit (C7, R14, D8), an output of the comparator is mixed with the output of the oscillator and causes the power modulator (U3) to provide an output voltage to the power output stage through the gate of the third transistor (M3) so that current flow through the load (L1) is increased and a magnetic field at the load (L1) is sustained, and wherein when a second voltage that is less than an output of the voltage reference circuit to the disable terminal, the control circuit is disabled and the active circuit is deactivated.

An exemplary method for actuating an inductive load of a load circuit with an active circuit is disclosed, the active circuit including a power output circuit and a control circuit; the power output circuit including: a first capacitor (C1) and a first diode (D1) that are connected in series across a positive terminal and a negative terminal of the load circuit; a second diode (D4) having an anode connected at a node between the first capacitor (C1) and the first diode (D1), and a cathode connected to a gate of a first transistor (M1); the first transistor (M1) having a drain connected to a gate of a second transistor (M2), and a gate connected to the negative terminal of the load circuit; the second transistor (M2) having a drain connected to the anode of the second diode (D4) and a source connected to a cathode of a clamping diode (D6); and the clamping diode (D6) having an anode connected to the gate of a third transistor (M3), which has a drain and a source connected to the positive terminal and negative terminal, respectively, of the load circuit; an active terminal (Pin 3) connected to an anode (AN11) of a third diode D11 and a cathode (CAT11) of the third diode D11 is connected to the gate (G3) of the third transistor (M3); and a disable terminal (Pin 5) connected to a cathode (CAT15) of the diode D15 and an anode (AN15) of the diode D15 is connected to the gate (G3) of the transistor (M3); the control circuit including: a constant voltage circuit connected to the gate of the third transistor (M3) and the negative terminal of the load circuit through an input diode (D7); an oscillator (U1) having an output connected to an inverting input terminal of a power modulator (U3); a voltage reference circuit (C7, R14, D8) connected to the negative terminal of the load circuit; and a comparator (U2) having a non-inverting input connected to the positive terminal of the load circuit and an inverting input connected to the voltage reference circuit (C7, R14, D8); and an active terminal (Pin 4) is connected to the inverting input (INV2) of the voltage comparator (U2) of the control circuit, the method comprising: applying a load voltage across the positive and negative terminals of the load circuit; applying a first voltage to the active terminal, wherein the second diode (D4) enters a conduct state when the load circuit reaches a specified voltage less than the load voltage, which causes each of the first transistor (M1), the second transistor (M2), and the third transistor (M3) to enter a conducting state such that after a specified period the power output circuit shuts off; and wherein when a voltage value at the non-inverting terminal of the comparator (U2) exceeds a voltage of the voltage reference circuit (C7, R14, D8), an output of the comparator is mixed with the output of the oscillator and causes the power modulator (U3) to provide an output voltage to the power output stage through the gate of the third transistor (M3) so that current flow through the load (L1) is increased and a magnetic field at the load (L1) is sustained, the method further comprising: applying a second voltage to the disable terminal to disable the control circuit and deactivate the active circuit, wherein the second voltage is less than the voltage reference circuit.

### BRIEF DESCRIPTION OF THE DRAWINGS

In the following, the disclosure will be described in greater detail by means of exemplary embodiments with reference to the attached drawings, in which

FIG. 1 illustrates a power control circuit in accordance with known implementation.

FIG. 2 is a plot of solenoid parameters during a sustaining phase in accordance with a known implementation.

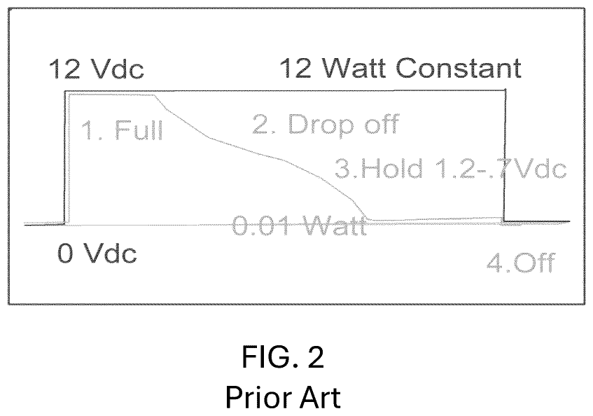

FIGS. 3A to 3C illustrate exemplary power control circuit configurations in accordance with an exemplary embodiment of the present disclosure.

FIG. 4 illustrates an exemplary passive power control circuit in accordance with an exemplary embodiment of the present disclosure.

FIG. 5 illustrates an exemplary active power control circuit in accordance with an exemplary embodiment of the present disclosure.

Further areas of applicability of the present disclosure will become apparent from the detailed description provided hereinafter. The detailed descriptions of exemplary embodiments are intended for illustration purposes only and are, therefore, not intended to necessarily limit the scope of the disclosure.

### DETAILED DESCRIPTION

Exemplary embodiments of the present disclosure provide circuits and methods for passively and actively driving an inductive load. The exemplary circuits disclosed herein can be used in combination with a load circuit that includes a relay, such as an electromagnetic relay, a solenoid, or any other suitable circuit including a coil and which is used for opening or closing a circuit based on an electrical signal that excites the coil. The exemplary circuits include an arrangement of two circuits where a first circuit clamps the power through the device long enough to activate it, and a second circuit, operates to sustain enough power to the load to maintain activation. When the relay is actuated and the mechanical component moves into the final position, the magnetic field strength of the relay is not required to be as strong to maintain it in position as in the initial actuation phase. For example, there is a difference of about 100 times or greater to 1 in terms of required power during actuation and the power required to maintain the magnetic field strength. For this reason, the second circuit does not directly regulate the voltage, but rather the second circuit is configured to modulate the voltage applied to the load by intermittently activating a power modulator. As a result, the exemplary embodiments disclosed herein, provide circuits and methods for controlling and/or driving a relay with a 99% reduction of sustaining power consumption.

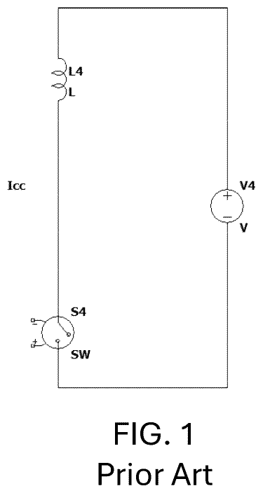

The exemplary driving circuits (PLRC) of the present disclosure improve on the operation of known circuits for an inductive load as shown in FIG. 1 by substantially reducing power loss during operation. For example, the active and passive circuits of the present disclosure reduce power loss by lowering the sustaining power after a period of less than a second to about 1% of the rated power. For example, the relay can be rated for both AC and DC power using the formula:

$$P = \frac{{V}^{2}}{R}$$

Where P is the power in watts, Vis the voltage across the coil, and R is the resistance of the coil in ohms.

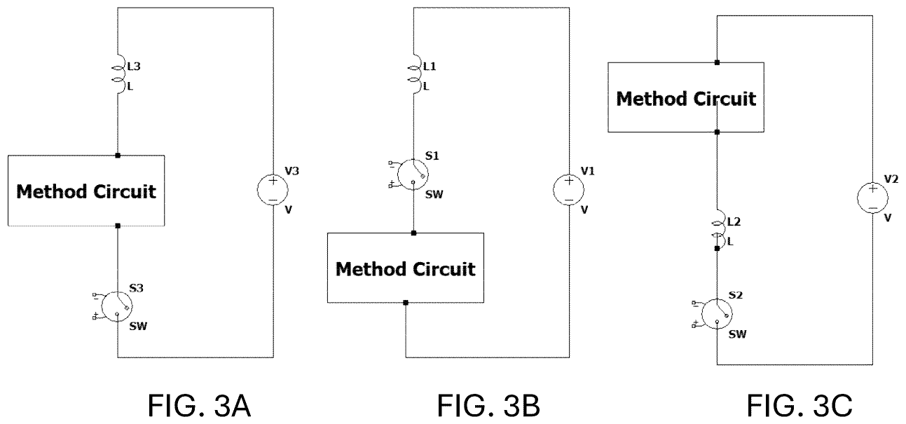

FIGS. 3A-3C illustrate exemplary driving circuits with alternative connections to an active solenoid circuit in accordance with an exemplary embodiment of the present disclosure. As shown in FIGS. 3A-3C, each circuit incorporates an interactive loop for controlling the voltage across the load L. The circuits operate by switching the power output stage on and off in short bursts while monitoring the output voltage. By regulating the switching of the power output stage, the circuits eliminate the power loss that an analog control circuit normally produces.

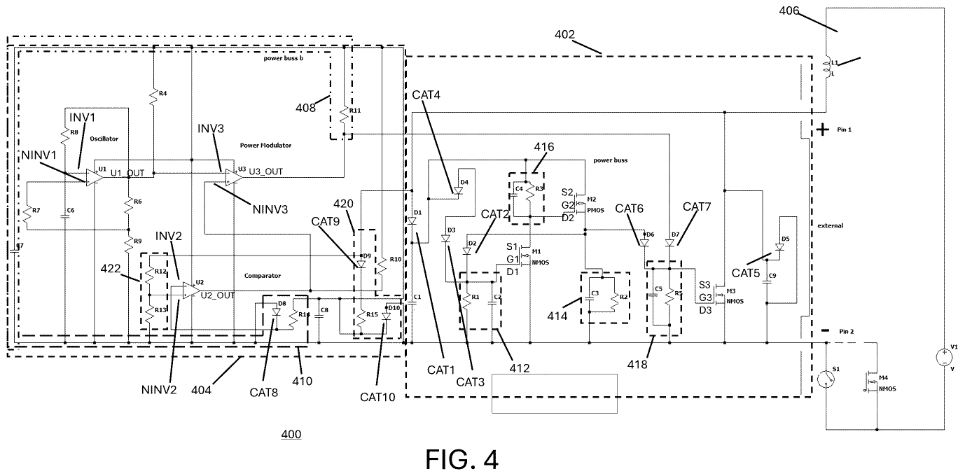

FIG. 4 illustrates a passive driving circuit in accordance with an exemplary embodiment of the present disclosure.

As shown in FIG. 4, the PLRC circuit 400 includes a power output circuit 402, a control circuit 404, and a load circuit 406. The power output circuit 402 is configured to output power to the load circuit 406. The power output circuit 402 includes a capacitor (C1) and a diode (D1) that are connected in series across a positive terminal (Pin 1) and a negative terminal (Pin 2) of the load circuit 406. The power output circuit 402 includes a diode (D4) having an anode (AN1) connected at a node (N1) between the capacitor (C1) and the diode (D1), and a cathode (CAT1) connected to a gate (G1) of a transistor (M1). The transistor (M1) has a drain (DRN1) that is connected to a gate (G2) of a transistor (M2). A gate (G1) of the transistor (M1) is connected to the negative terminal (Pin 2) of the load circuit 406. The transistor (M2) of the power output circuit 402 has a drain (DRN2) that is connected to the anode (AN2) of the diode (D4) and a source (S2) that is connected to a cathode (CAT6) of a clamping diode (D6). The clamping diode (D6) has an anode (AN2) that is connected to the gate (G3) of a transistor (M3). The transistor (M3) has a drain (DRN3) and a source (S3) that are connected to the positive terminal (Pin 1) and the negative terminal (Pin 2), respectively, of the load circuit 406.

The power output circuit 402 includes an RC circuit 412 (R1, C2) that is connected to the gate (G1) of the transistor (M1) and the negative terminal (Pin 2) of the load circuit 406. The RC circuit 412 includes a resistor (R1) and capacitor C2 that are connected in parallel between the gate (G1) of the transistor M1 and the negative terminal (Pin 2) of the load circuit 406. A diode D3 is connected between the transistor M1 and the diode D4. For example, the diode D3 has a cathode (CAT3) that is connected to the cathode (CAT4) of the diode D4 and an anode AN3 that is connected to the gate G1 of the transistor M1.

The power output circuit 402 also includes an RC circuit 414 (R2, C3) that is connected to the source S2 of transistor M2 and the negative terminal (Pin 2) of the load circuit 406. The RC circuit 414 includes a resistor R2 and a capacitor C3 that are connected in parallel between the source S2 of transistor M2 and the negative terminal (Pin 2) of the load circuit 406.

Still further, the power output circuit 402 also includes an RC circuit 416 (R3, C4) that is connected at one end to a node N3 connecting the gate G2 of the transistor (M2) and the drain (DRN1) of the transistor (M1), and at the other end to the node N1 between the capacitor C1 and the diode D1. The RC circuit 416 including a resistor R3 connected in parallel with a capacitor C4 between nodes N3 and N1. first transistor (M1) is connected to charge the third RC circuit (R3, C4) and cause the gate of the second transistor (M2) to conduct.

The power output circuit 402 includes a diode D5 connected in parallel with a capacitor C9 between the positive terminal (Pin 1) and the negative terminal (Pin 2) of the load circuit 406. According to an exemplary embodiment, the diode D5 is connected to provide reverse polarity protection to the capacitor C9 and the capacitor C9 is connected to stabilize power across the positive (Pin 1) and negative (Pin 2) terminals of the load circuit.

The power output circuit 402 includes an RC circuit 418 that is connected between the gate G3 of the transistor M3 and the negative terminal (Pin 2) of the load circuit 406. The RC circuit 418 includes a resistor R5 and a capacitor C5 connected in parallel between the gate G3 of the transistor M3 and the negative terminal (Pin 2) of the load circuit 406. The RC circuit 418 is configured to be charged when one of diodes D6 and D7 is conducting. The charging of the RC circuit 418 causes current to flow through the gate G3 of transistor M3.

As shown in FIG. 4, the control circuit 404 is configured to control the power generated by the power output circuit 402 and provided by the power output circuit 404 to the load circuit 406. The control circuit 404 includes a constant voltage circuit 408 (R11, C7) that is connected to the gate (G3) of the transistor (M3) and the negative terminal (Pin 2) of the load circuit 406 through an input diode (D7). The input diode D7 provides current for the sustaining phase generated by the constant voltage circuit 408. The control circuit 404 includes an oscillator (U1) having its output (U1_OUT) connected to an inverting input (INV3) terminal of a power modulator (U3). The oscillator (U1) is connected to provide a switching aspect for the power modulator (U3). The oscillator output (U1_OUT) is fed back to the inverting input terminal (INV1) of the oscillator (U1) via a resistor R8. A capacitor C6 is also connected between the inverting input (INV1) terminal of the oscillator and Pin2 of the load circuit 406. The non-inverting input (NINV1) of the oscillator (U1) is connected to a divider circuit via resistor R7. The divider circuit includes a resistor R6 that is connected to the output (U1_OUT) of the oscillator U1 and a resistor R9 that is connected to Pin 2 of the load circuit 406. According to an exemplary embodiment, the oscillator (U1) can be configured to operate at an unregulated frequency of 50 KHz. A voltage reference circuit 410 of the control circuit 404 is connected to the negative terminal (Pin 2) of the load circuit 406. The voltage reference circuit 410 can include a capacitor (C7), a resistor (R14), and a Zener diode (D8) that are connected in series. According to an exemplary embodiment, one end of the capacitor (C7) is connected to the resistor (R14) and another end connected to the negative terminal (Pin 2) of the load circuit 406. The Zener diode (D8) has a cathode (CAT8) connected to the resistor (R14) and the inverting terminal (INV2) of a voltage comparator U2 and an anode (AN8) connected to the negative terminal (Pin 2) of the load circuit 406. The power control circuit 404 further includes a voltage comparator (U2) having a non-inverting input (NINV2) connected to the positive terminal of the application circuit and an inverting input (INV2) connected to node N2 of the voltage reference circuit 410.

The control circuit 404 also includes a switch regulator circuit 420 (D9, R15, D10) that is connected between the positive terminal (Pin 1) of the load circuit 406 and the negative terminal (Pin 2) of the load circuit 406. According to an exemplary embodiment, the switch regulator 420 includes a diode D9, a resistor R15, and a Zener diode D10 connected in series, where the resistor R15 is connected between the cathodes (CAT9, CAT10) of diode D9 and D10, the anode of diode D9 is connected to the positive terminal (Pin 1) of the load circuit 406, and the anode of Zener diode D10 is connected to the negative terminal (Pin 2) of the load circuit 406. During operation, the Zener diode D10 is connected to generates a constant voltage source for the control circuit 404. When the current flows through the switch regulator 420, for example, through diode D9 to resistor R15 and to Zener diode D10, a constant voltage source is generated to power the constant voltage circuit 408 of the control circuit 404.

The control circuit 404 also includes a voltage divider circuit 422 connected to the non-inverting input (NINV2) of the comparator U2. The voltage divider circuit 422 includes a resistor R12 and a resistor R13 having a common connection to the non-inverting input (NINV2) of the voltage comparator U2. The other end of the resistor R12 is connected to the positive terminal (Pin 1) of the load circuit 406 and the other end of the resistor R13 is connected to the negative terminal (Pin 2) of the load circuit 406. According to an exemplary embodiment, the voltage divider circuit 422 is configured to divide the input voltage, which is the voltage at Pin 1 of the load circuit 406, by two (2).

During operation, the diode D4 of the power output circuit 402 enters a conducting state (i.e., the applied voltage meets its rated voltage) when the load circuit 406 reaches a specified voltage based on the current flowing through the coil. For example, according to an exemplary embodiment the load circuit 404 can include a solenoid (S1) having a rated voltage of 12V, at 1 amp and 12 watts. The load circuit 406 includes a coil 412 that is charged to 12V rating of the solenoid (S1) for actuation. Once the charge on the coil 412 reaches the specified voltage, each of the first transistor (M1), the second transistor (M2), and the third transistor (M3) enter a conducting state such that after a specified period the power output circuit shuts off. According to an exemplary embodiment, the specified period can be determined empirically for a specific application, and measures the elapsed time needed to guarantee that the relay has fully activated, then the circuit shuts off. For example, for quarter (¼) inch snap air valve rated at 12.0 Vdc, the specified period can be four (4) seconds or less. For example, prior to the specified period being reached, the voltage drop across the positive terminal (Pin 1) and the negative terminal (Pin 2) of the load circuit 406 increases. This increase in voltage causes the output (U2_OUT) of the comparator (U2) to shut off when the specified period is reached. The load circuit 406 is deactivated when the comparator U2 turns off.

Further, when the diode D4 enters the conducting state, it charges the RC circuit 412 through diode D3. The RC circuit 414 is connected to be charged through the transistor M2. Once charged, the RC circuit 414 causes the gate G3 of the transistor M3 to enter the conducting state. The RC circuit 416 is connected to be charged by the transistor M1 and causes the gate G2 of the transistor M2 to conduct once charged.

Voltage comparator U2 is connected to receive the input voltage at Pin 1 on its non-inverting input (NINV2) is divided by 2 in the resistor pair R12 and R13 and the output of the voltage reference circuit 410 on its inverting input (INV2). These two voltages are compared, such that when the value of the voltage on the positive terminal (Pin 1) of the load circuit 406 exceeds the sustaining voltage, indicating the voltage drop across the load is low, the voltage comparator U2 senses a higher voltage such that the output (U2_OUT) will be a voltage value closer to the value of the positive terminal (Pin 1) of the load circuit. According to an exemplary embodiment, the voltage on Pin 1 exceeding the sustaining voltage indicates that the voltage drop across the load L1 is low (e.g., the voltage drop is below the voltage specified for sustaining the relay in the activated state). For example, for the exemplary quarter (¼) inch snap air valve, the voltage across the load L1 is reduced from 12 vdc to a low voltage of 1.16 vdc. The low voltage drop across the load L1 enables the power modulator U3 to provide power to the load L1. The power modulator (U3) mixes the output (U2_OUT) of the voltage comparator (U2) and the output (U1_OUT) of the oscillator (U1). The output (U3_OUT) of the oscillator (U3) is a voltage value that is provided to the power output circuit 402 to draw more current through the load circuit 406 and sustaining the magnetic field on the load L1. After a specified period, the voltage drop across the load L1 will increase turning off the output (U2_OUT) of the voltage comparator (U2) and the load L1 is turned off until the voltage comparator (U2) again senses a higher voltage and the process repeats. According to an exemplary embodiment, the specified period measures the time elapsed after the current flow raises the voltage drop across the load (L1) to the level determined for the specific relay application to remain in the activated state. For example, for the exemplary quarter (¼) inch snap air valve, the specified period of 300 ms to guarantee activation. This sustains a low power magnetic field in the coil until the external control elements disable the circuit and it powers off.

After a specified period, a voltage drop across the load L1 increases, which causes the output (U2_OUT) of the comparator (U2) to shut off and turns off the load circuit 406.

When the voltage at the positive terminal (Pin 1) of the comparator (U2) exceeds a voltage of the voltage reference circuit 410, an output (U2_OUT) of the comparator (U2) is mixed with the output (U1_OUT) of the oscillator (U1) and causes the power modulator (U3) to provide an output voltage (U3_OUT) to the power output stage 402 through the gate (G3) of the third transistor (M3) so that current flow through the load (L1) is increased and a magnetic field at the load (L1) is sustained. For example, the sustaining power, provided through the output voltage (U3_OUT) of the power modulator (U3) is approximately 1% of the rated power of the load circuit. According to an exemplary embodiment, if the rated power of the solenoid (S1) is 12 watts, the sustained power is 0.12 watts. As a result, the exemplary circuit 400 can result in lower power loss and lower operating temperatures. Further, the circuit 400 can reduce overall industrial process heat impact and increase coil life due to reduced thermal stress. Lower operating temperatures can extend the active time of the circuit 400 from several hours to an indefinite period and can indefinitely extend the operative life of the device. Because of the lower operating temperatures and thermal stresses, the exemplary circuit 400 described herein can eliminate and/or substantially reduce failures in an inductive load caused by these circumstances. For the exemplary quarter (¼) inch snap air valve, operating at its activation voltage (12.0 Vdc) for at least five (5) minutes at 79° F., results in a case temperature of 133-147° F. When connected to the passive driving circuit of FIG. 4, the sustaining voltage of the snap air valve is reduced to 1.16 vdc at 0.123 watts. This results in a sustained case temperature of 81-82° F. after at least 30 minutes of operation and for continuous operation of at least 72 hours.

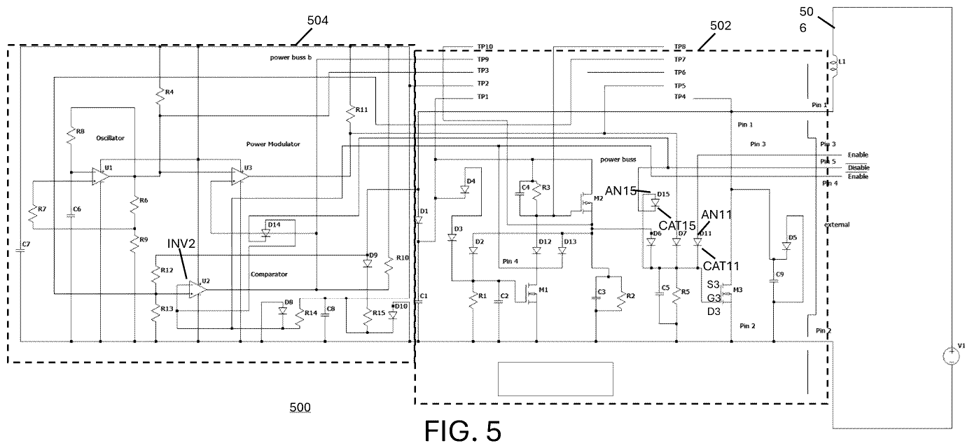

FIG. 5 illustrates an active power control circuit in accordance with an exemplary embodiment of the present disclosure.

As shown in FIG. 5, the active circuit 500 includes a power output circuit 502, control circuit 504, and a load circuit 506. The power output circuit 402 is configured to include the same arrangement of components as described with respect to the power output circuit 402 of FIG. 4. Similarly, the control circuit 504 is configured to include the same arrangement of components as described with respect to the control circuit 404 of FIG. 3. The load circuit 506 includes a load L1, a positive terminal (Pin 1) and a negative terminal (Pin 2). In addition, the active circuit 500 includes plural terminals that are configured to receive an external control signal, such that turning on the power and off are now controlled by 3 inputs. According to an exemplary embodiment, an active terminal (Pin 3) is connected to the gate of the transistor (M3) of the power control circuit 502 through a diode D11, a disable terminal (Pin 5) is connected to the gate of the transistor (M3) of the power control circuit 402 through a diode D15, and an inverted active terminal (Pin 4) is connected to the inverted input (INV2) of the voltage comparator (U2) of the control circuit 504. For example, the active terminal (Pin 3) is connected to an anode (AN11) of the diode D11 and a cathode (CAT11) of the diode D11 is connected to the gate (G3) of the transistor (M3). The disable terminal (Pin 5) is connected to the cathode (CAT15) of the diode D15 and an anode (AN15) of the diode D15 is connected to the gate (G3) of the transistor (M3). The active terminal (Pin 3) is configured to receive a voltage to activate the circuit. In one configuration of the active circuit 500, the active terminal (Pin 3) can be pulled to a high voltage value to activate the circuit, and in another configuration, the inverted active terminal (Pin 4) can be pulled to a low voltage value to activate the circuit 500. According to an exemplary embodiment in which Pin 3 is used to activate the circuit, the high voltage value can be voltage level that is higher than one-half (½) of the normal component operating voltage to activate the circuit. For another exemplary configuration in which Pin 4 is used to active the circuit, the low voltage value can be a voltage level that is lower than one-half (½) the normal component operating voltage to activate the circuit. For example, for the exemplary quarter (¼) inch snap air valve, the Pin 3 voltage value can be higher than 6 vdc and the Pin 4 voltage value can be lower than 6 vdc.

Once the circuit 500 is activated, it will continue to provide a sustaining voltage to the load circuit 506 until the disable terminal (Pin 5) is pulled low.

According to an exemplary embodiment, the active circuit 500 can include one or more the test points (TP1 to TP10) for internal validation procedures.

According to another exemplary embodiment, the plural transistors (M1, M2, M3) can be any suitable transistor as desired for performing the operations disclosed herein. For example, the plural transistors can be configured as power metal oxide semiconductor field effect transistors (MOSFETs).

According to yet another exemplary embodiment, the transistor M1 and the transistor M3 are configured with the same type of doping material.

According to an exemplary embodiment, the oscillator (U1), the comparator (U2), and the power modulator (U3) can include operational amplifiers.

In an exemplary use case for the passive and active circuits 400 and 500, these circuits can be configured to control a load circuit having a solenoid rated at 12 volts, 1 amp, and 12 watts, or a load circuit having an air valve rated at 12-watts. For these use cases, each exemplary circuit can be arranged to include discrete circuit components can have the values provided in Table 1. It should be readily apparent that the discrete values provided below can be suitably applied to a load circuit having a different configuration as described above.

TABLE 1
Components List

| # | Designation | Value |
|---|---|---|
| 1 | C1 | 22 mf |
| 2 | C2 | 22 mf |
| 3 | C3 | 22 mf |
| 4 | C4 | 22 mf |
| 5 | C5 | 22 mf |
| 6 | C6 | 22 mf |
| 7 | C7 | 100 uf |
| 8 | C8 | 22 mf |
| 9 | C9 | 100 uf |
| 10 | D1 | Power Mixer |
| 11 | D2 | Power Mixer |
| 12 | D3 | Power Mixer |
| 13 | D4 | Zener |
| 14 | D5 | Power Mixer |
| 15 | DE | Power Mixer |
| 16 | D7 | Power Mixer |
| 17 | D8 | Zener |
| 18 | D9 | Power Mixer |
| 19 | D10 | Zener |
| 20 | D11 | Power Mixer |
| 21 | D12 | Power Mixer |
| 22 | D13 | Power Mixer |
| 23 | D14 | Power Mixer |
| 24 | D15 | Power Mixer |
| 25 | M1 | MOSFET |
| 26 | M2 | MOSFET |
| 27 | M3 | MOSFET |
| 28 | R1 | 10K |
| 29 | R2 | 10K |
| 30 | R3 | 10K |
| 31 | R4 | 2K |
| 32 | R5 | 10K |
| 33 | R6 | 10K |
| 34 | R7 | 10K |
| 35 | R8 | 100K |
| 36 | R9 | 10K |
| 43 | R10 | 10K |
| 44 | R11 | 10K |
| 45 | R12 | 10K |
| 46 | R13 | 10K |
| 47 | R14 | 10K |
| 48 | R15 | 10K |
| 49 | U1 | Comparator |
| 50 | U2 | Power Modulator |
| 51 | U3 | Oscillator |

The exemplary passive circuit 400 of FIG. 4 and the active circuit 500 of FIG. 5 can provide several advantages for reducing power loss in electro-magnetic mechanical components. For example, each circuit can reduce power loss to virtually 100 milliwatts for a typical solenoid, eliminate thermal aging as a factor in life cycle planning, reduce other vibration related failures because of no thermal aging, and reduce facility waste heat. The exemplary circuits 400 and 500 described herein can limit temperature fluctuation from an off state to indefinite operation in an active state to one (1) degree or less. Furthermore, when the load circuit is configured to include a solenoid, the passive and active circuits 400 and 500 allow the solenoid to operate in an active state indefinitely. In addition, a solenoid can be used in applications where heat, time on, and high failure rates were prohibitive factors. according to operating and circuit parameters of an exemplary embodiment disclosed herein, activated coils can reach a temperature of 50 C°, and after 4 hours of activation the coil temperature increases only 1° C. above ambient temperature.

The exemplary embodiments described herein can be used in the control of traffic lights using simple relays that will now last for as long as solid state devices at a fraction of the cost and at a much higher efficiency. For example, an exemplary traffic light system at an intersection has at least twelve (12) 150 watt lights. In general the circuit is arranged such that opposing red and green lights are on the same circuit. Given this arrangement, there are 2 sets of driver circuits for red/green lights and two independent sets of drivers for the yellow lights. The control circuits for the lights consume 20 watts of power. This change would reduce those costs to only the light of the signal's energy. Because the exemplary control circuits disclosed herein can reduce the power used by the relay to about 1% of rated power the total savings amount to at least four (4) times 20-80 watts. The power system across multiple intersections can be on the order of tens of millions reduction of power consumption.

The exemplary embodiments, described herein can also be applied for controlling the voltage level in relay applications for maritime shipboard power reduction, aerospace and orbital solar powered platforms, micro nanocircuit applications, large industrial magnets such as particle beam focusing magnets and accelerator section magnets used for industrial metal bending and scientific research, magnets used in obtaining magnetic resonance measurements, maglev and other transportation magnet systems, door security magnets, high Tesla magnetic assemblies for obtaining nuclear MRI measurements, and other suitable applications where a electromagnetic coil is excited for activating/deactivating a circuit.

It should be apparent to a person skilled in the art that the exemplary embodiments described herein can be implemented in various ways. As such, the disclosure and its embodiments are not limited to the examples described above but can vary within the scope of the claims.

The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A passive circuit for driving an inductive load, the passive circuit comprising:
a power output circuit and a control circuit;
the power output circuit including:
a first capacitor (C1) and a first diode (D1) that are connected in series across a positive terminal and a negative terminal of a load circuit that includes the inductive load;
a second diode (D4) having an anode connected at a node between the first capacitor (C1) and the first diode (D1), and a cathode connected to a gate of a first transistor (M1);
the first transistor (M1) having a drain connected to a gate of a second transistor (M2), and a gate connected to the negative terminal of the application circuit;
the second transistor (M2) having a drain connected to the anode of the second diode (D4) and a source connected to a cathode of a clamping diode (D6); and
the clamping diode (D6) having an anode connected to the gate of a third transistor (M3), which has a drain and a source connected to the positive terminal and negative terminal, respectively, of the application circuit;
the control circuit including:
a constant voltage circuit connected to the gate of the third transistor (M3) and the negative terminal of the application circuit through an input diode (D7);
an oscillator (U1) having an output connected to an inverting input terminal of a power modulator (U3);
a voltage reference circuit (C7, R14, D8) connected to the negative terminal of the application circuit; and
a comparator (U2) having a positive input connected to the positive terminal of the application circuit and a negative input connected to the voltage reference circuit (C7, R14, D8),
wherein the second diode (D4) enters a conduct state when the application circuit reaches a specified voltage, which causes each of the first transistor (M1), the second transistor (M2), and the third transistor (M3) to enter a conducting state such that after a specified period the power output circuit shuts off, and
wherein when a voltage value at the positive terminal of the comparator (U2) exceeds a voltage of the voltage reference circuit (C7, R14, D8), an output of the comparator is mixed with the output of the oscillator and causes the power modulator (U3) to provide an output voltage to the power output stage through the gate of the third transistor (M3) so that current flow through the load (L1) is increased and a magnetic field at the load (L1) is sustained.

2. The passive circuit of claim 1, comprising:
a third diode having a cathode connected to the cathode of the second diode and an anode connected to the gate of the first transistor (M1).

3. The passive circuit of claim 2, comprising:
a first RC circuit (R1, C2) connected to the gate of the first transistor (M1) and the negative terminal of the application circuit, wherein the second diode (D4) is connected to charge the first RC circuit through the third diode.

4. The passive circuit of claim 3, comprising:
a second RC circuit (R2, C3) connected to the source of the second transistor (M2) and the negative terminal of the application circuit, wherein the second transistor (M2) is connected to charge the second RC circuit (R2, C3) and cause the gate of the third transistor (M3) to conduct.

5. The passive circuit of claim 4, comprising:
a third RC circuit (R3, C4) connected on a first end to the gate of the second transistor (M2) and the drain of the first transistor (M1), and on a second end to the node between the first capacitor (C1) and the first diode (D1), wherein first transistor (M1) is connected to charge the third RC circuit (R3, C4) and cause the gate of the second transistor (M2) to conduct.

6. The passive circuit of claim 5, comprising:
a fourth diode connected in parallel with a second capacitor (C9) between the positive terminal and the negative terminal of the application circuit, wherein the fourth diode is connected to provide reverse polarity protection and the second capacitor (C9) is connected to stabilize power across the positive terminal and the negative terminal of the application circuit.

7. The passive circuit of claim 6, comprising:
a fourth RC circuit (R5, C5) connected between the gate of the third transistor (M3) and the negative terminal of the application circuit.

8. The passive circuit of claim 1, comprising:
a switch regulator circuit (D9, R15, D10) connected between the cathode of the input diode (D9) and the negative terminal of the application circuit, the switch regulator including a fifth diode, a first resistor, and a Zener diode connected in series, wherein the Zener diode generates a constant voltage source for the control circuit.

9. The passive circuit of claim 1, comprising:
a voltage divider circuit connected to the positive terminal of the comparator.

10. The passive circuit of claim 1, wherein after a specified period, a voltage drop across the positive and negative terminals of the application circuit will increase causing the output of the comparator (U2) to shut off and turns off the application circuit.

11. The passive circuit of claim 1, wherein the first transistor (M1), the second transistor (M2), and the third transistor (M3) are power metal oxide semiconductor field effect transistors (MOSFETs).

12. The passive circuit of claim 11, wherein the first transistor (M1) and the third transistor (M3) have a same type of doping material.

13. The passive circuit of claim 1, wherein the oscillator (U1), the comparator (U2), and the power modulator (U3) are operational amplifiers.

14. An active circuit for driving an inductive load, the active circuit including a power output circuit and a control circuit;
the power output circuit including:
a first capacitor (C1) and a first diode (D1) that are connected in series across a positive terminal and a negative terminal of a load circuit that includes the inductive load;
a second diode (D4) having an anode connected at a node between the first capacitor (C1) and the first diode (D1), and a cathode connected to a gate of a first transistor (M1);
the first transistor (M1) having a drain connected to a gate of a second transistor (M2), and a gate connected to the negative terminal of the load circuit;
the second transistor (M2) having a drain connected to the anode of the second diode (D4) and a source connected to a cathode of a clamping diode (D6); and
the clamping diode (D6) having an anode connected to the gate of a third transistor (M3), which has a drain and a source connected to the positive terminal and negative terminal, respectively, of the load circuit;
an active terminal (Pin 3) connected to an anode (AN11) of a third diode D11 and a cathode (CAT11) of the third diode D11 is connected to the gate (G3) of the third transistor (M3); and
a disable terminal (Pin 5) connected to a cathode (CAT15) of the diode D15 and an anode (AN15) of the diode D15 is connected to the gate (G3) of the transistor (M3);
the control circuit including:
a constant voltage circuit connected to the gate of the third transistor (M3) and the negative terminal of the load circuit through an input diode (D7);
an oscillator (U1) having an output connected to an inverting input terminal of a power modulator (U3);
a voltage reference circuit (C7, R14, D8) connected to the negative terminal of the load circuit; and
a comparator (U2) having a non-inverting input connected to the positive terminal of the load circuit and an inverting input connected to the voltage reference circuit (C7, R14, D8),
wherein a load voltage across the positive and negative terminals of the load circuit, a first voltage to the active terminal, and the second diode (D4) enters a conducting state when the load circuit reaches a specified voltage less than the load voltage, which causes each of the first transistor (M1), the second transistor (M2), and the third transistor (M3) to enter a conducting state such that after a specified period the power output circuit shuts off;
wherein when a voltage value at the non-inverting terminal of the comparator (U2) exceeds a voltage of the voltage reference circuit (C7, R14, D8), an output of the comparator is mixed with the output of the oscillator and causes the power modulator (U3) to provide an output voltage to the power output stage through the gate of the third transistor (M3) so that current flow through the load (L1) is increased and a magnetic field at the load (L1) is sustained, and
wherein when a second voltage that is less than an output of the voltage reference circuit to the disable terminal, the control circuit is disabled and the active circuit is deactivated.

15. A method for driving an inductive load with an active circuit, the active circuit including a power output circuit and a control circuit;
the power output circuit including:
a first capacitor (C1) and a first diode (D1) that are connected in series across a positive terminal and a negative terminal of a load circuit that includes the inductive load;
a second diode (D4) having an anode connected at a node between the first capacitor (C1) and the first diode (D1), and a cathode connected to a gate of a first transistor (M1);
the first transistor (M1) having a drain connected to a gate of a second transistor (M2), and a gate connected to the negative terminal of the load circuit;
the second transistor (M2) having a drain connected to the anode of the second diode (D4) and a source connected to a cathode of a clamping diode (D6); and
the clamping diode (D6) having an anode connected to the gate of a third transistor (M3), which has a drain and a source connected to the positive terminal and negative terminal, respectively, of the load circuit;
an active terminal (Pin 3) connected to an anode (AN11) of a third diode D11 and a cathode (CAT11) of the third diode D11 is connected to the gate (G3) of the third transistor (M3); and
a disable terminal (Pin 5) connected to a cathode (CAT15) of the diode D15 and an anode (AN15) of the diode D15 is connected to the gate (G3) of the transistor (M3);
the control circuit including:
a constant voltage circuit connected to the gate of the third transistor (M3) and the negative terminal of the load circuit through an input diode (D7);
an oscillator (U1) having an output connected to an inverting input terminal of a power modulator (U3);
a voltage reference circuit (C7, R14, D8) connected to the negative terminal of the load circuit; and
a comparator (U2) having a non-inverting input connected to the positive terminal of the load circuit and an inverting input connected to the voltage reference circuit (C7, R14, D8); and
an active terminal (Pin 4) is connected to the inverting input (INV2) of the voltage comparator (U2) of the control circuit 404, the method comprising:
applying a load voltage across the positive and negative terminals of the load circuit;
applying a first voltage to the active terminal,
wherein the second diode (D4) enters a conduct state when the load circuit reaches a specified voltage less than the load voltage, which causes each of the first transistor (M1), the second transistor (M2), and the third transistor (M3) to enter a conducting state such that after a specified period the power output circuit shuts off; and
wherein when a voltage value at the non-inverting terminal of the comparator (U2) exceeds a voltage of the voltage reference circuit (C7, R14, D8), an output of the comparator is mixed with the output of the oscillator and causes the power modulator (U3) to provide an output voltage to the power output stage through the gate of the third transistor (M3) so that current flow through the load (L1) is increased and a magnetic field at the load (L1) is sustained,
the method further comprising:
applying a second voltage to the disable terminal to disable the control circuit and deactivate the active circuit, wherein the second voltage is less than the voltage reference circuit.
